(19) United States
(12) Patent Application Publication
(10) Pub. No.: US 2010/0235339 A1
(43) Pub. Date: Sep. 16, 2010

(54) Search Advice Systems and Methods

(75) Inventors: Jesse Lee Anderson, Bend, OR (US); Mark Knowles, Bend, OR (US)

Correspondence Address: Stevens Law Group, 1754 Technology Drive, Suite #226, San Jose, CA, 95110, US

(73) Assignee: PixelSilk, Bend, OR (US)

(21) Appl. No.: 12/703,122

(22) Filed: Feb. 9, 2010

Related U.S. Application Data
(60) Provisional application No. 61/151,094, filed on Feb. 9, 2009.
(60) Provisional application No. 61/232,753, filed on Aug. 10, 2009.

(51) Int. Cl. G06F 17/30

(52) U.S. Cl. 707/706; 707/769; 707/E17.108

(57) ABSTRACT

A computer-implemented method receives search optimization advice and applies the search optimization advice to a web page associated with a web site. The method generates a recommendation to modify the web page for improved search engine performance based on application of the search optimization advice. The recommendation to modify the web page is displayed proximate the web page content associated with the recommendation.

### RELATED APPLICATIONS

This application claims the benefit of U.S. Provisional Application No. 61/151,094, filed Feb. 9, 2009, the disclosure of which is incorporated by reference herein. This application also claims the benefit of U.S. Provisional Application No. 61/232,753, filed Aug. 10, 2009, the disclosure of which is incorporated by reference herein.

### BACKGROUND

Owners and developers of web sites and web-based content often desire to have their web site (or particular web pages in the web site) ranked favorably in search engine results pages. In many situations, a high ranking in a search engine results page results in a significant number of visitors to the web site because more users see a highly ranked entry in the search engine results than a lower ranked entry. For many web sites, a high search engine ranking is important to the success of the business or activity associated with the web site.

As a result of the desire to achieve high search engine rankings, many individuals and businesses attempt to provide good search engine rankings for web sites. These individuals and businesses typically perform a manual analysis of web site content and suggest manual changes to the web site content in an attempt to improve search engine ranking of the web page. The recommended procedures for achieving high search engine rankings change over time. Thus, the manual procedures for changing web site content are applied repeatedly in response to each change in the recommended procedures for achieving high search engine rankings.

It is therefore desirable to provide an improved system and method for achieving and maintaining high search engine rankings over time.

### BRIEF DESCRIPTION OF THE DRAWINGS

Similar reference numbers are used throughout the figures to reference like components and/or features.

FIG. 1 is a block diagram illustrating an example environment capable of implementing the systems and methods discussed herein.

FIG. 2 is a block diagram illustrating various components of a search advice system.

FIG. 3 is a flow diagram illustrating an embodiment of a procedure for optimizing web-based content.

FIG. 4 is a flow diagram illustrating an embodiment of a procedure for analyzing and recommending modifications to web-based content.

FIG. 5 is a flow diagram illustrating an embodiment of a procedure for determining whether web pages associated with a web site are in compliance with search optimization advice.

FIG. 6 is a flow diagram illustrating an embodiment of a procedure for notifying one or more users of an attempt to post non-compliant content on a web site.

FIG. 7 illustrates an example display identifying multiple web pages associated with a web site and the compliance status of each web page.

FIG. 8 illustrates an example display containing web page information and associated search advice.

FIG. 9 illustrates an example display that allows a user to enter one or more keywords.

FIG. 10 illustrates an example display containing advice regarding various parameters associated with a web page.

FIG. 11 illustrates an example display of a content editor including a search advice tab.

FIG. 12 illustrates an example display containing search advice regarding keywords and other parameters associated with web-based content.

FIGS. 13A and 13B illustrate an example database schema capable of use with the systems and methods discussed herein.

FIG. 14 is a block diagram illustrating an example computing device.

### DETAILED DESCRIPTION

The systems and methods described herein provide a convenient and responsive way to achieve and maintain good search rankings over time. The described systems and methods regularly obtain the latest advice and recommendations associated with search engine optimization (SEO) and analyze existing web sites and web pages using the latest advice and recommendations. Based on this analysis, areas of potential improvement are identified, such as portions of the web-based content that is not in compliance with the latest advice and recommendations. Implementing the suggested improvements or changes may enhance the web site's results in the search rankings.

As used herein, the term “advice” refers to any guidelines, recommendations, parameters, suggestions or other advice related to web-based content. Advice may be received from one or more sources, such as an individual, an organization or other entity. The term “element” is used herein to refer to web page content, objects, components, and so forth about which advice is provided. Example elements include title tags, meta description tags, meta keyword tags, H1 tags, H2 tags, body tags, anchor tags, emphasis tags, and the like. In particular embodiments, elements are associated with a particular web page or other web-based content. As used herein, “search optimization” refers to an attempt to improve the search results (e.g., search ranking) of web-based content based.

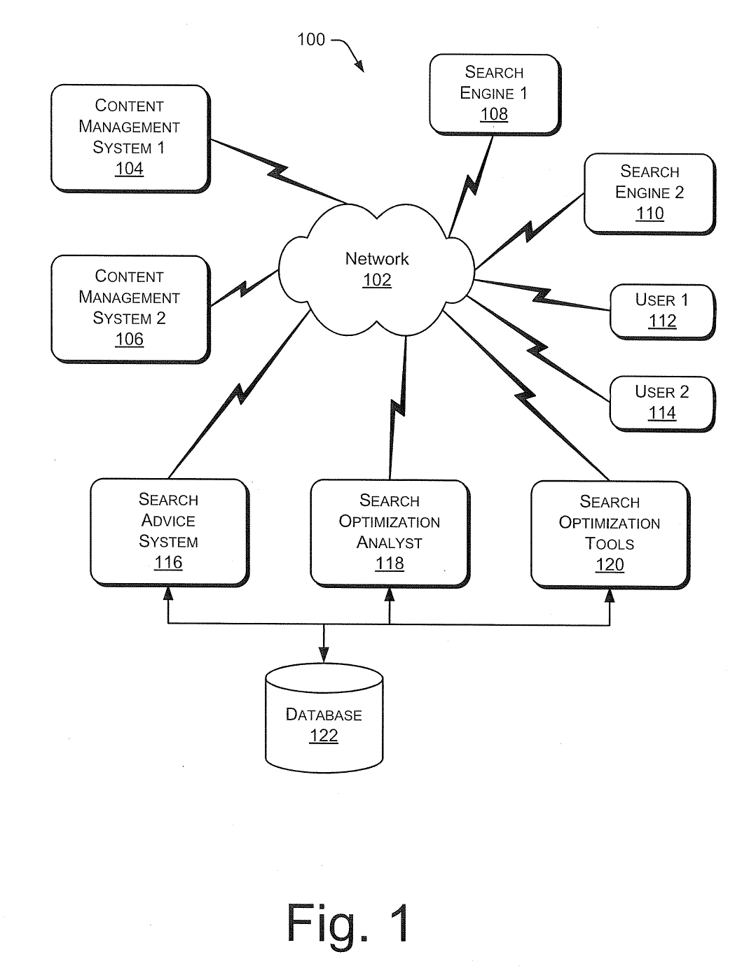

FIG. 1 is a block diagram illustrating an example environment 100 capable of implementing the systems and methods discussed herein. A data communication network 102, such as the Internet, communicates data among a variety of devices, including content management systems, search engines, user devices, and so forth. Data communication network 102 may be a combination of two or more networks communicating data using various communication protocols and any communication medium.

The embodiment of FIG. 1 includes content management systems 104 and 106, which represent one or more web servers or similar devices that receive, manage and distribute content across network 102. Environment 100 also includes search engines 108 and 110, which search for content on content management systems, web servers and other content sources accessible via network 102. Search engines 108 and 110 are accessed by multiple users (e.g., users 112 and 114 shown in FIG. 1), who are seeking specific content (e.g., web-based content). A user enters search criteria (e.g., one or more keywords) that defines the content desired by the user. Search engines 108 and 110 identify multiple content offerings from multiple content sources, rank the content offerings based on the content's relevancy to the user's search criteria, and display the highest ranked content offerings to the user.

Although environment 100 illustrates two content management systems 104, 106, two search engines 108, 110, and two users 112, 114, particular environments may include any number of content management systems, search engines, users, and other devices.

The embodiment of FIG. 1 also includes a search advice system 116, a search optimization analyst 118, and one or more search optimization tools 120 configured to communicate with each other and with other devices via network 102. Search advice system 116 retrieves search engine optimization advice and recommendations from one or more sources, such as search optimization analyst 118 and search optimization tools 120, and applies the retrieved advice and recommendations to web-based content. Search advice system 116 then prepares recommendations for one or more web pages (or a web site) to optimize the search engine ranking for the web page(s). Search advice system 116 also provides a user interface that allows a user to apply one or more recommendations to the associated web content.

Search optimization analyst 118 and search optimization tools 120 provide various advice, guidelines, suggestions, recommendations, and parameters for optimizing search engine rankings for web content. The advice, guidelines, suggestions, recommendations, and parameters may be provided by an individual or organization, including third-party individuals and organizations not associated with the manufacturer or provider of search advice system 116 or content management system 104, 106. Search optimization analyst 118 and search optimization tools 120 may update their associated advice, guidelines, suggestions, recommendations, and parameters in response to changes in the procedures used by search engines to identify, analyze, rank, and display web-based content. In a particular embodiment, search optimization analyst 118 is an individual or entity that provides search optimization advice, and search optimization tools 120 are software tools that provide search advice based on current search engine analysis and ranking procedures.

A database 122 is coupled to communicate with search advice system 116, search optimization analyst 118, and search optimization tools 120, as shown in FIG. 1. Database 122 stores various information related to web-based content, search engine optimization advice, guidelines, suggestions, recommendations, parameters, and related content optimization data.

Although search advice system 116, search optimization tools 120, and database 122 are shown in FIG. 1 as separate components, in particular implementations any two or more of these components can be combined into a single device or system. Additional details regarding search advice system 116, search optimization analyst 118, search optimization tools 120, and database 122 are provided herein.

As shown in FIG. 1, search advice system 116 is a network-accessible system that communicates with content management systems 104, 106 and search optimization analyst 118 and tools 120. Search advice system 116 serves as a repository for search advice information and applies that advice to content stored on content management systems 104, 106.

Various APIs (application programming interfaces) are used to communicate data between the components and systems shown in FIG. 1. For example, APIs exist between search advice system 116 and search optimization tools 120. Other APIs exist between search advice system 116 and content management systems 104, 106. In particular embodiments, these APIs are HTTP Request/Response systems. In specific implementations, search advice system 116 communicates with content management systems 104, 106 using JavaScript (with HTTP requests/responses) via AJAX (asynchronous JavaScript and XML) within a browser.

Browser security often prevents a script from accessing resources on another domain. For example, if search advice system 116 is at Domain1 and the web site being analyzed for search advice is on Domain2, the browser session at Domain2 will not allow the script to access the search advice system API directly. One solution to this restriction uses the “<head>” area of the HTML code to bring in script files from other domains that execute the script already on the web page (from the web site's domain). Alternatively, a “proxy” can be established in which certain predefined requests are re-routed on the web site's server to the search advice system.

As discussed herein, web page content includes various tags, many of which are used by search engines to evaluate and rank web pages. Example tags often used by search engines include a title tag, a meta description tag, a meta keyword tag, an H1 tag, a body tag, an emphasis tag (e.g., bold or strong), and an anchor tag. The content of these tags are commonly analyzed by search engines to determine which web pages are best presenting the topic associated with the web page. For example, search engines may evaluate the number of words in a particular tag and the number of times a particular keyword appears in a tag or the number of times a particular keyword appears in a web page.

Another parameter considered by search engines is the number of inbound links to a particular web page. Inbound links are links from web pages outside the web site being evaluated that link to a particular web page being analyzed.

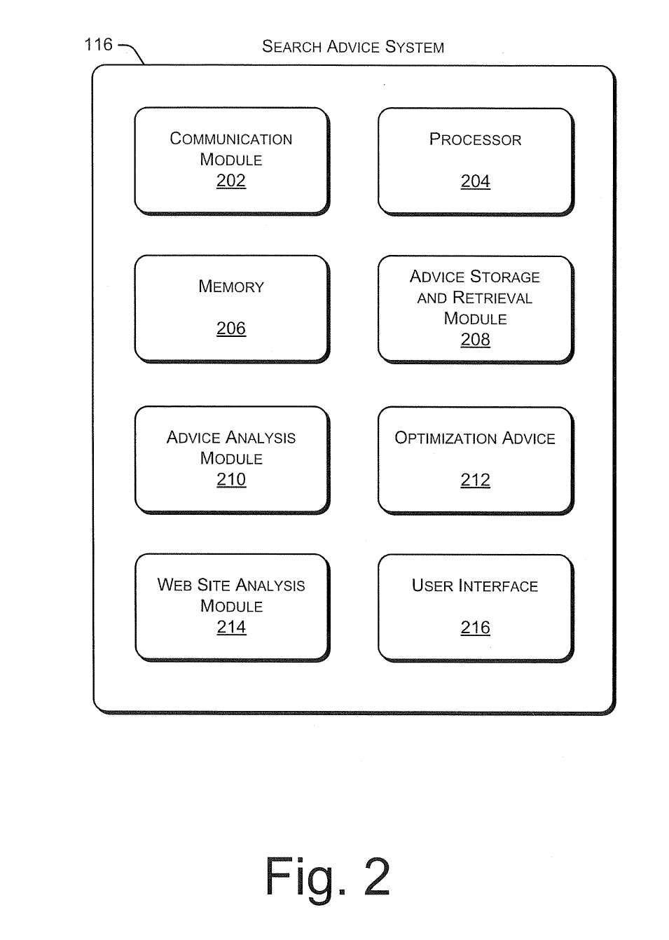

FIG. 2 is a block diagram illustrating various components of search advice system 116, which includes a communication module 202, a processor 204, and a memory 206. Communication module 202 allows search advice system 116 to communicate with other devices and systems, such content management systems 104, 106 shown in FIG. 1. Processor 204 executes various instructions to implement the functionality provided by search advice system 116. Memory 206 stores these instructions as well as other data used by processor 204 and other modules contained in search advice system 116.

Search advice system 116 also includes an advice storage and retrieval module 208, which stores and retrieves various search advice. In a particular embodiment, advice storage and retrieval module 208 retrieves search advice from search optimization analyst 118 and search optimization tools 120. In other embodiments, advice storage and retrieval module 208 stores data to and retrieves data from database 122.

An advice analysis module 210 uses various search advice and optimization parameters 212 to analyze web pages, web sites, and other web-based content. This analysis applies search advice, optimization parameters, and the like to identify changes to the analyzed content that is likely to improve the ratings of the content in one or more search engines. A web site analysis module 214 analyzes site maps, web pages, and web site structures to identify content in a particular web site. The individual web pages and other content can then be analyzed by advice analysis module 210, which also generates one or more recommendations for content changes to improve search results.

A user interface 216 allows administrators, web developers, and other user to interact with the various components of search advice system 116. In certain embodiments, user interface 216 also allows a user to interact with one or more content management systems or other devices via the Internet or other data network. In other embodiments, user interface 216 allows a user to enter search optimization advice, guidelines, recommendations, and so forth. This user-entered search optimization advice may be used alone or in combination with advice from one or more search optimization analysts 118 and/or one or more search optimization tools 120. Particular user interface examples are discussed herein.

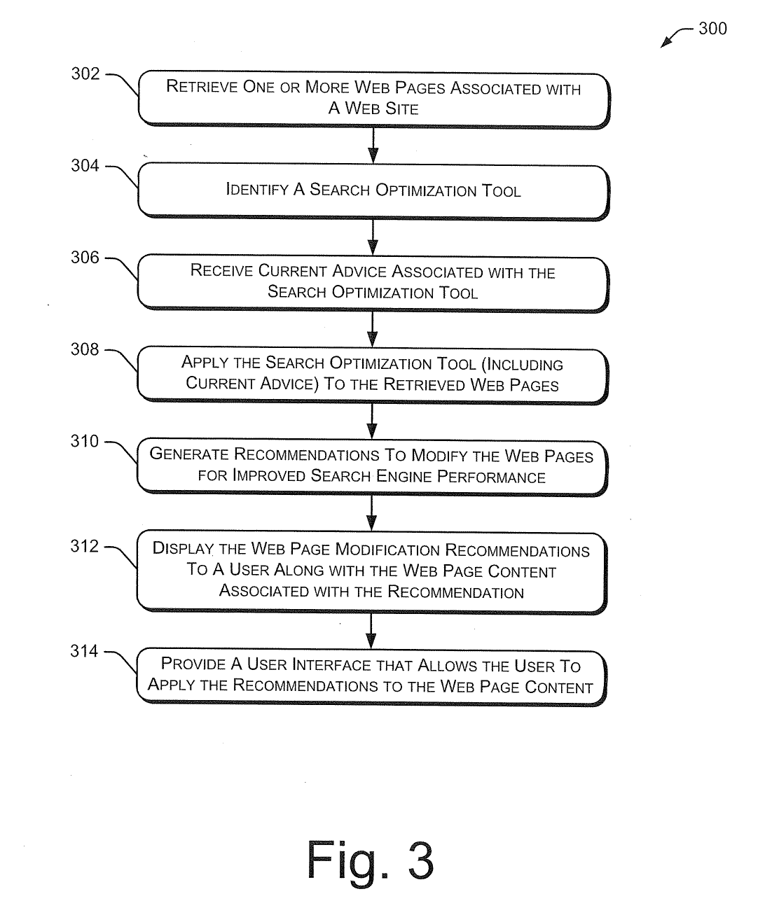

FIG. 3 is a flow diagram illustrating an embodiment of a procedure 300 for optimizing web-based content. Initially, the procedure retrieves one or more web pages associated with a web site (block 302). The retrieved web pages can be identified by a user, identified from a site map, or other identification mechanism. Procedure 300 then identifies a search optimization tool (block 304). This search optimization tool may be created by the creator of the search advice system or created by a third party. In alternate embodiments, procedure 300 identified multiple search optimization tools. The procedure then receives current advice associated with the search optimization tool (block 306). Thus, each time procedure 300 is performed, the current optimization advice is received. This ensures that the procedure is applying the latest version of the optimization advice when analyzing web content.

Procedure 300 continues by applying the search optimization tool (including the current advice) to the retrieved web pages (block 308). After applying the search optimization tool, the procedure generates recommendations to modify the web pages for improved search engine performance (block 310). The web page modification recommendations are then displayed to a user along with the web page content associated with the recommendation (block 312). In a particular embodiment, the web page modification recommendations are displayed simultaneously with the web page content, such that the recommendations are updated immediately after changes to the web page content are entered. Procedure 300 provides a user interface that allows the user to apply the recommendations to the web content (block 314). Thus, the user can easily apply the recommended changes to the web page content and see that the recommendations are satisfied. Additional examples of this simultaneous display of the web page content and recommended changes are discussed herein.

In particular embodiments, the procedure of FIG. 3 is repeated at periodic intervals to identify changes to advice provided in the search optimization tool. In other embodiments, the search optimization tool (or other system/entity) sends an update notification each time the advice provided by the search optimization tool is modified. In this embodiment, the procedure of FIG. 3 is launched each time an update notification is received regarding an update to the search optimization tool advice.

In another embodiment, default advice can be provided automatically to one or more web pages associated with a web site. This default advice typically contains general best practices for web pages. The advice can be implemented automatically by making changes to the web site content, or presented to a user (e.g., web site administrator) for approval prior to making changes to the web site content.

When providing a user interface that allows the user to apply recommendations to the web page content, the user may be given the opportunity to provide multiple versions of a particular tag or other information. For example, the user may be given an opportunity to enter multiple title tags having varying length, such as an 8-, 9-, 10- and 11-word title tag. By providing these varying lengths of title tags, the systems and methods described herein can automatically change the title tag used with the web site based on changes to the current search advice. For example, if a search optimization tool was previously advising the use of an 8-word title tag and that advice changes to recommending a 10-word title tag, the system can automatically change the title tag to the 10-word version previously supplied by the user. Similar procedures are also useful with other tags discussed herein.

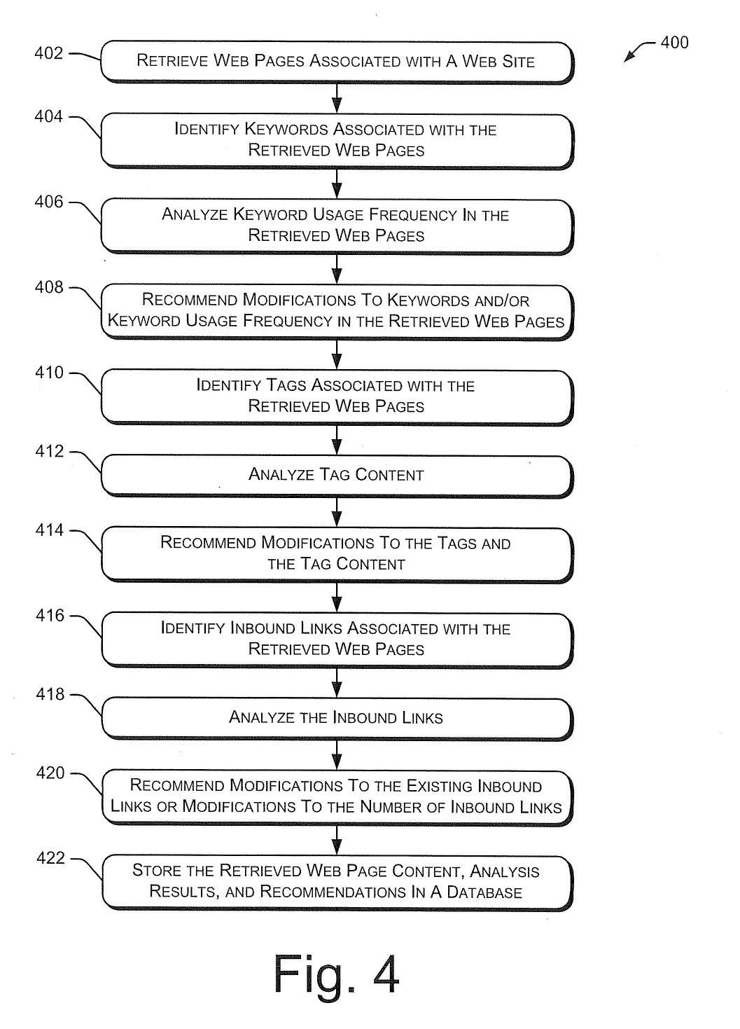

FIG. 4 is a flow diagram illustrating an embodiment of a procedure 400 for analyzing and recommending modifications to web-based content. Initially, procedure 400 retrieves web pages associated with a web site (block 402) and identifies keywords associated with the web pages (block 404). The procedure analyzes keyword usage frequency in the retrieved web pages (block 406) and recommends modifications to keywords and/or keyword usage frequency in the retrieved web pages (block 408).

Procedure 400 continues by identifying various tags associated with the retrieved web pages (block 410). Example tags include the title tag, H1 tag, and H2 tag. The procedure then analyzes the tag content (block 412) and recommends modifications to the tags and tag content (block 414) based on current advice associated with one or more search optimization tools, as discussed herein. Procedure 400 then identifies inbound links associated with the retrieved web pages (block 416) and analyzes those inbound links (block 418). The procedure then recommends modifications to the existing inbound links or recommends modifications to the number of inbound links (block 420) to improve search engine results. Finally, procedure 400 stores the retrieved web content, analysis results, and recommendations in a database or other storage mechanism (block 422).

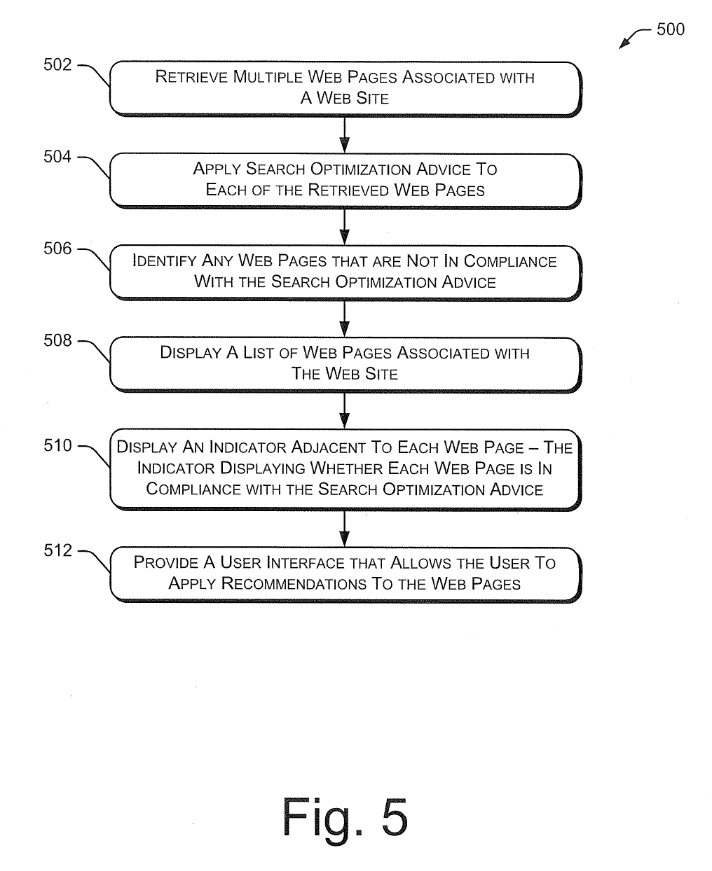

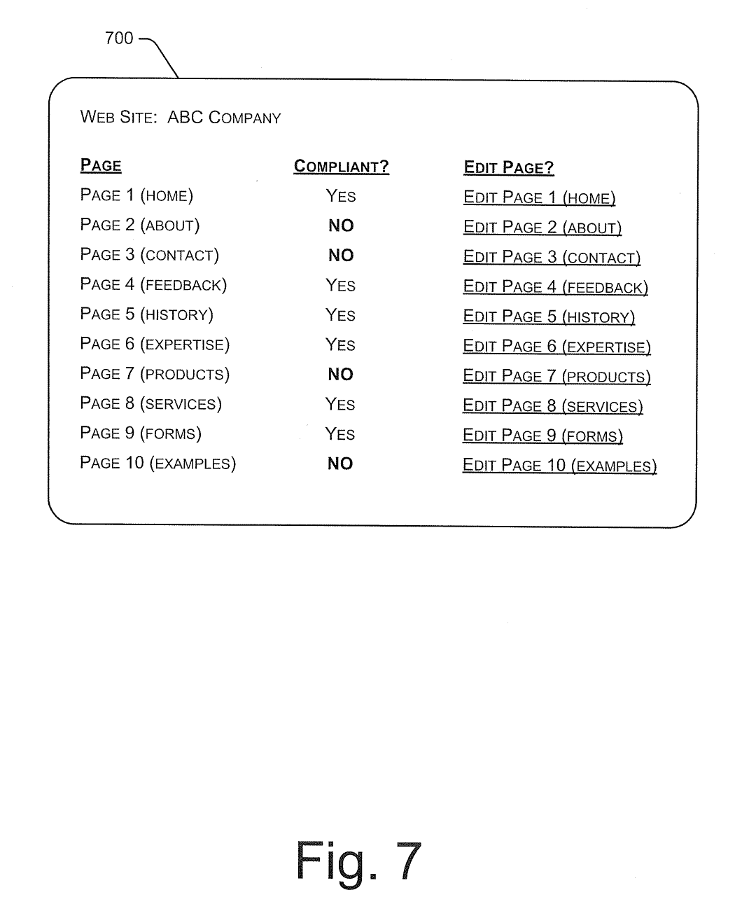

FIG. 5 is a flow diagram illustrating an embodiment of a procedure 500 for determining whether web pages associated with a web site are in compliance with search optimization advice. The procedure begins by retrieving multiple web pages associated with a web site (block 502) and applying search optimization advice to each of the retrieved web pages (block 504). Web pages associated with a web site can be identified and retrieved, for example, using a site map or analyzing the page structure of the web site. Procedure 500 identifies any web pages that are not in compliance with the search optimization advice (block 506) and displays a list of web pages associated with the web site (block 508). When displaying the list of web pages associated with the web site, a particular indicator is displayed near each web page indicating whether the web page is in compliance with the search optimization advice (block 510). In a particular implementation, web pages that are not in compliance are highlighted or displayed in a different color (e.g., displaying compliant web page indicators in green and non-compliant web page indicators in red). The procedure also provides a user interface that allows the user to apply one or more recommendations to the web pages (block 512). An example display and user interface is shown in FIG. 7, and discussed below.

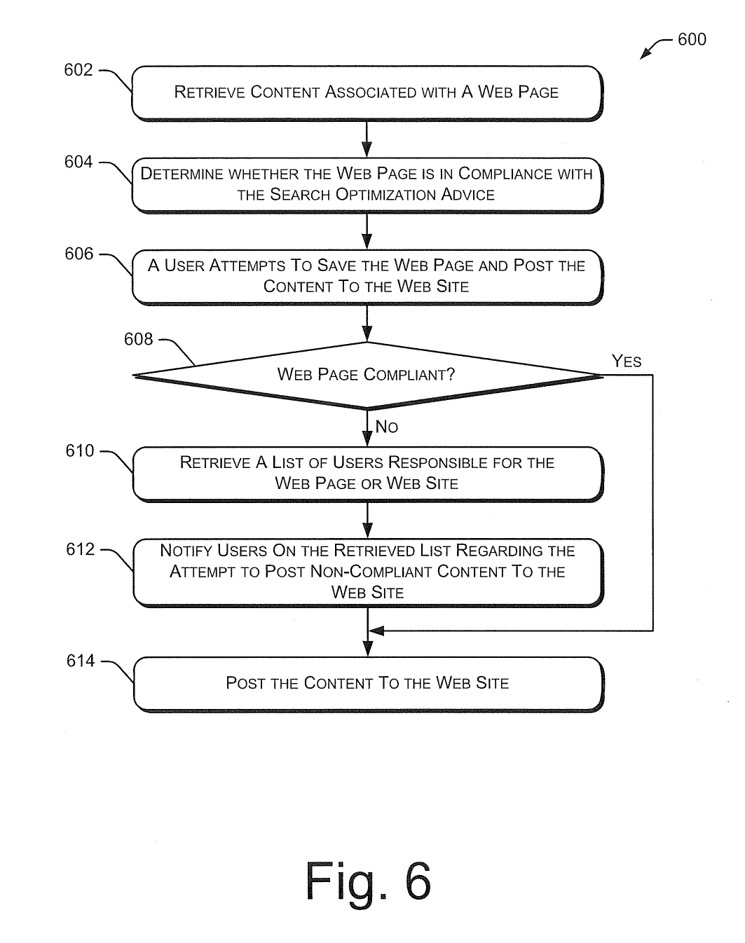

FIG. 6 is a flow diagram illustrating an embodiment of a procedure 600 for notifying one or more users of an attempt to post non-compliant content on a web site. Initially, the procedure retrieves content associated with a web page (block 602) and determines whether the web page is in compliance with current search optimization advice (block 604), as discussed herein. When a user attempts to save the web page and post the web page content “live” to the web site (block 606), the procedure determines whether the web page content is compliant with the search optimization advice (block 608). If the web page is compliant with the search optimization advice, the content is posted to the web site (block 614).

If the web page content is not compliant with the search optimization advice, procedure 600 retrieves a list of users responsible for the web page or web site (block 610). This list of users may include managers, administrators, web site developers, and the like. The procedure then notifies users on the retrieved list regarding the attempt to post non-compliant web content to the web site (block 612). This notification can be performed via email, text message, fax, phone call, or other notification mechanism. The content is then posted to the web site (block 614). This procedure ensures that appropriate users are made aware of the non-compliant web content posted to a web site and given an opportunity to correct the situation.

FIG. 7 illustrates an example display 700 identifying multiple web pages associated with a web site and the compliance status of each web page. As shown in FIG. 7, a particular web site has ten web pages. Alternate web sites may contain any number of web pages arranged in any hierarchical structure. For each web page, display 700 indicates whether the web page is compliant with current search optimization advice applied to the web pages. Additionally, for each web page, a link is provided to edit the content of the web page. This editing is useful in bringing the web page content into compliance with the search optimization advice, or editing the web page content for other purposes. In a particular embodiment, display 700 uses different colors or highlighting to distinguish non-compliant web pages from compliant web pages. For example, Page 1 (compliant) is shown in a normal text and normal color, while Page 2 (not compliant) is shown in a different color (e.g., red) and/or highlighted.

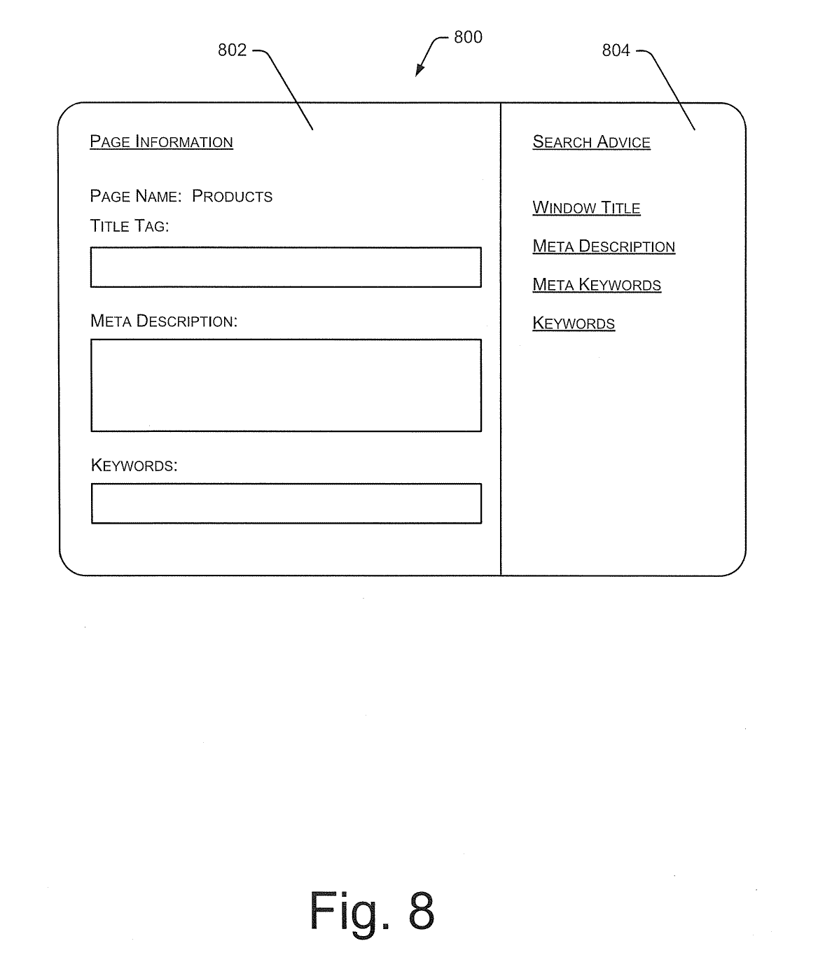

FIG. 8 illustrates an example display 800 containing web page information and associated search advice. In the example of FIG. 8, the web page information 802 (e.g., a portion of the web page content) is displayed simultaneously with multiple search advice categories or recommendations 804. In this example, the search advice categories/recommendations are active links that open a separate window (or change the appearance of search advice portion 804) with specific recommendations, such as specific window title recommendations or specific meta description recommendations. In other examples, one or more specific recommendations are displayed in the search advice portion 804 of display 800 along with the associated web page information or web page content. Web page information 802 displays existing information (if any) and provides the opportunity to create new information or edit the existing information associated with the web page. As discussed herein, any changes to the existing web page content will update the recommendations in the search advice portion 804 of the display 800. For example, if a change to the existing web page content eliminates a recommendation to change the window title (e.g., the recommendation has been satisfied by the content change), that recommendation is removed from the display.

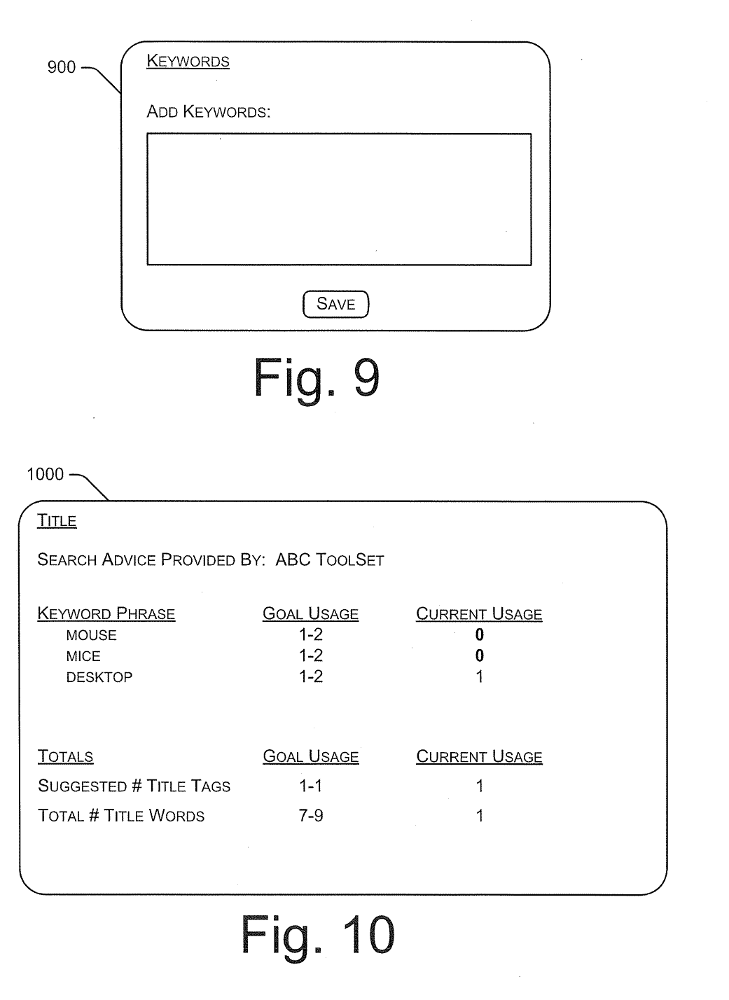

FIG. 9 illustrates an example display 900 that allows a user to enter one or more keywords. In a particular embodiment, display 900 is presented in the page information portion 802 of display 800 (FIG. 8). Display 900 provides the user an opportunity to add one or more keywords to the list of keywords associated with a particular web page or web site.

FIG. 10 illustrates an example display 1000 containing advice regarding various parameters associated with a web page. In a particular embodiment, display 1000 is presented in the search advice portion 804 of display 800 (FIG. 8). FIG. 10 shows that the search advise provided is based on a particular SEO toolset (the “ABC Toolset”). Display 1000 shows that three keywords are being analyzed: “mouse”, “mice” and “desktop”. Based on the SEO toolset, each of the three keywords should be used 1-2 times on the web page. In this example, the “mouse” and “mice” keywords are not being used (Current Usage=0) and the “desktop” keyword is being used once. So, keywords “mouse” and “mice” are not compliant because they do not meet the minimum recommended usage (once). Thus, keywords “mouse” and “mice” should each be used once or twice in the web page to be compliant with the keyword recommendation. The “desktop” keyword is compliant with the keyword recommendation, so no further use of “desktop” is necessary for the example web page.

In the example of FIG. 10, display 1000 also includes a suggested number of title tags (one title tag) and a total number of words (7-9) in the title tag. In this example, the number of title tags is compliant with the recommendation, however the total number of words (one) is not compliant with the recommendation of 7-9 words in the title. Thus, a user is recommended to add another 6-8 words to the title to satisfy the recommendation of 7-9 words.

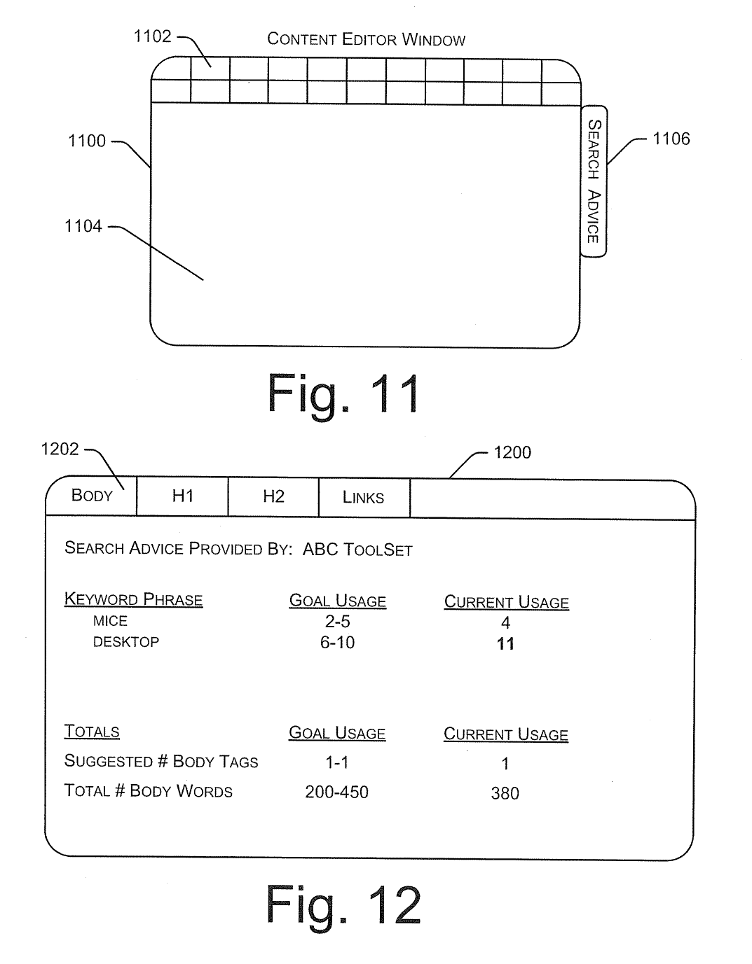

FIG. 11 illustrates an example display 1100 of a content editor including a search advice tab or activation button. The content editor window may be associated with a content management system, web server, or other editor associated with any content source. In the example of FIG. 11, the content editor window includes multiple editing operations/commands 1102 arranged across the top of display 1100. Additionally, display 1100 includes a content window 1104 that displays the current content being edited. A search advice tab 1106 expands display 1100 (or opens an additional display window) to show search advice associated with the content displayed in content window 1104. Example search advice displays are shown in FIGS. 10 and 12. Although search advice tab 1106 is shown in FIG. 11 as associated with a content editor window, similar search advice tabs can be associated with any field or any component of a system. For example, a search advice tab may be associated with a text editor, data entry system, data display system, or any other component or system. Additionally, the search advice tab can be positioned in any location relative to the field or window with which it is associated. The search advice tab can be located adjacent to a field or window (as shown in FIG. 11), located within a field or window, or located distant from a field or window.

FIG. 12 illustrates an example display 1200 containing search advice regarding keywords and other parameters associated with web-based content. Display 1200 includes multiple tabs 1202 across the top of the display, labeled “Body”, “H1”, “H2”, and “Links” These tabs identify categories of search advice available to be presented in display 1200. In the example of FIG. 12, the “Body” tab is activated such that display 1200 presents search advice related to the body of the web page content.

In FIG. 12, two keyword phrases “mice” and “desktop” are displayed and analyzed. In this example, the recommended usage of keyword “mice” is 2-5 times in the body of the web page, and the recommended usage of keyword “desktop” is 6-10 times in the body of the web page. As shown in FIG. 12, the current usage of keyword “mice” is 4, which is compliant with the recommendation, and the current usage of keyword “desktop” is 11, which is not in compliance with the recommendation. The user can bring the usage of keyword “desktop” into compliance with the recommendation by eliminating one use of the keyword “desktop” in the body content.

The recommendations shown in FIG. 12 also identify the use of one body tag, which is in compliance with the recommendation, and a total of 380 body words, which is also in compliance with the recommendation of 200-450 words.

The various procedures discussed herein may be executed on search advice system 116, as shown in FIG. 1. Alternatively, the described procedures can be executed on a content management system or any other device or system capable of receiving and applying search advice from a search optimization analyst, search optimization tool, or any other source of search advice.

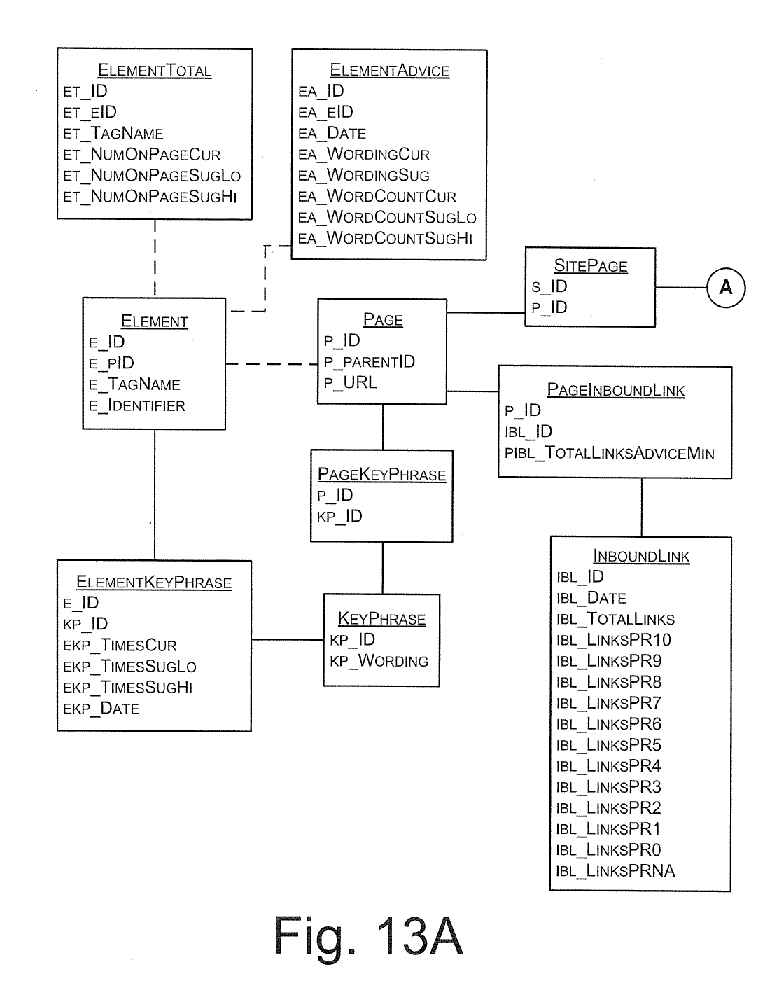

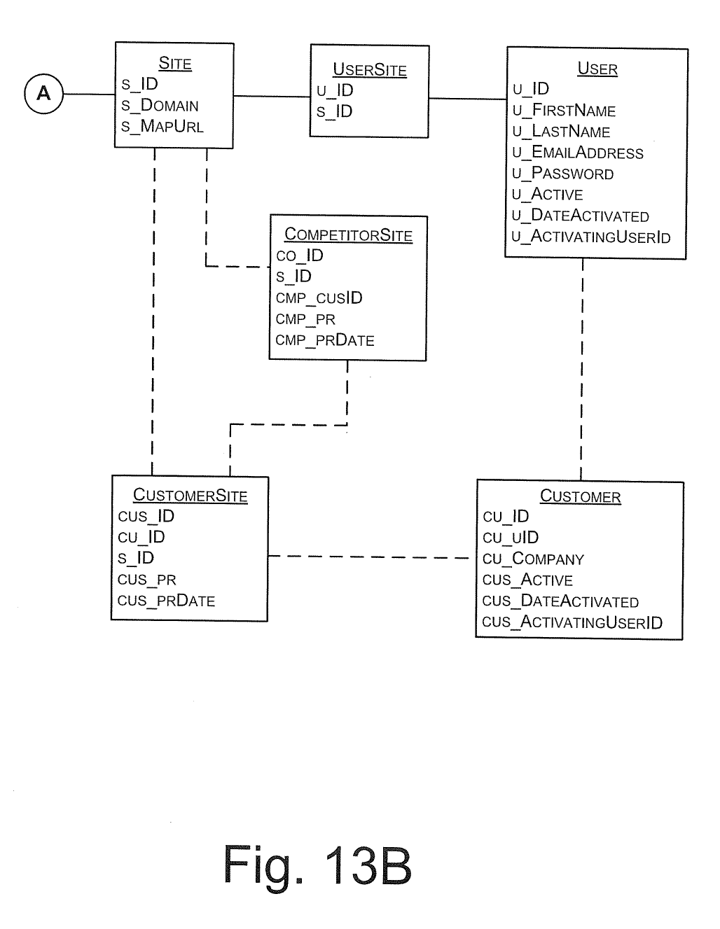

FIGS. 13A and 13B illustrate an example database schema capable of use with the systems and methods discussed herein. The database schema includes main tables such as “User”, “Customer”, “Site”, “Page”, “InboundLink”, “KeyPhrase”, and “Element” (also referred to as “tag”). The remaining tables in the schema relate to one of the main tables or interrelate two of the main tables. Rows in the “ElementAdvice” table relate to rows in the “Element” table and store some of the advice for the tag represented by the Element row called out. Additionally, the “UserSite” table interrelates the “User” table and the “Site” table, and its rows contain information regarding sites for which a logged on user can provide advice.

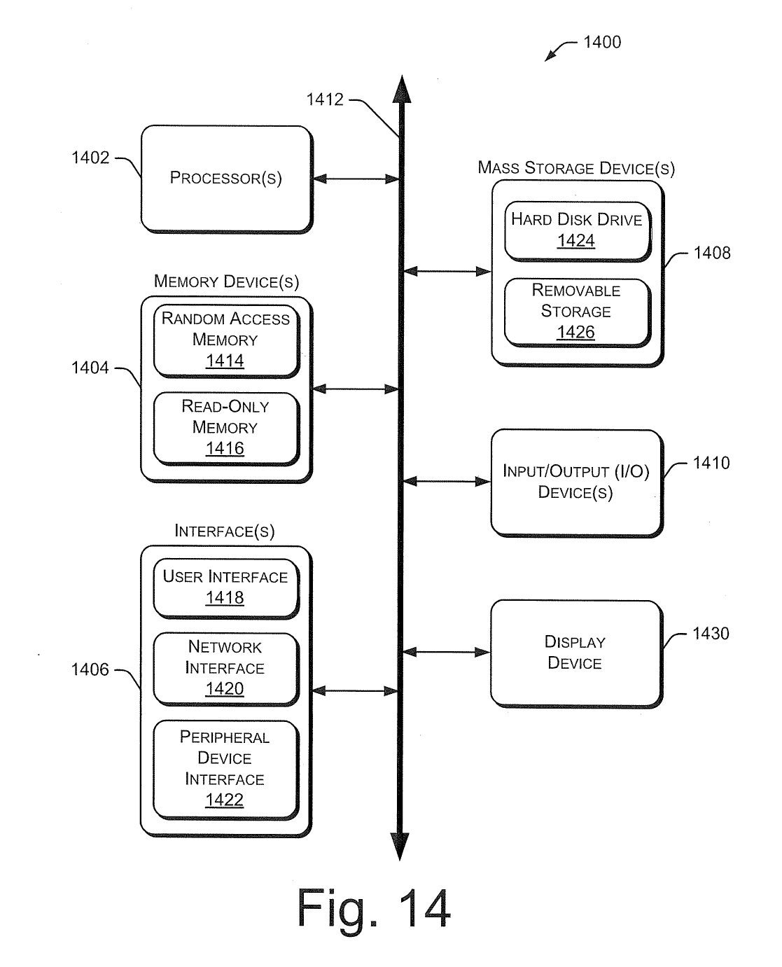

FIG. 14 is a block diagram illustrating an example computing device 1400. Computing device 1400 may be used to perform various procedures, such as those discussed herein. Computing device 1400 can function as a server, a client, or any other computing entity. Computing device 1400 can be any of a wide variety of computing devices, such as a desktop computer, a notebook computer, a server computer, a handheld computer, and the like.

Computing device 1400 includes one or more processor(s) 1402, one or more memory device(s) 1404, one or more interface(s) 1406, one or more mass storage device(s) 1408, one or more Input/Output (I/O) device(s) 1410, and a display device 1430 all of which are coupled to a bus 1412. Processor(s) 1402 include one or more processors or controllers that execute instructions stored in memory device(s) 1404 and/or mass storage device(s) 1408. Processor(s) 1402 may also include various types of computer-readable media, such as cache memory.

Memory device(s) 1404 include various computer-readable media, such as volatile memory (e.g., random access memory (RAM)) 1414 and/or nonvolatile memory (e.g., read-only memory (ROM) 1416). Memory device(s) 1404 may also include rewritable ROM, such as Flash memory.

Mass storage device(s) 1408 include various computer readable media, such as magnetic tapes, magnetic disks, optical disks, solid state memory (e.g., Flash memory), and so forth. As shown in FIG. 14, a particular mass storage device is a hard disk drive 1424. Various drives may also be included in mass storage device(s) 1408 to enable reading from and/or writing to the various computer readable media. Mass storage device(s) 1408 include removable media 1426 and/or non-removable media.

I/O device(s) 1410 include various devices that allow data and/or other information to be input to or retrieved from computing device 1400. Example I/O device(s) 1410 include cursor control devices, keyboards, keypads, microphones, monitors or other display devices, speakers, printers, network interface cards, modems, lenses, CCDs or other image capture devices, and the like.

Display device 1430 includes any type of device capable of displaying information to one or more users of computing device 1400. Examples of display device 1430 include a monitor, display terminal, video projection device, and the like.

Interface(s) 1406 include various interfaces that allow computing device 1400 to interact with other systems, devices, or computing environments. Example interface(s) 1406 include any number of different network interfaces 1420, such as interfaces to local area networks (LANs), wide area networks (WANs), wireless networks, and the Internet. Other interfaces include user interface 1418 and peripheral device interface 1422.

Bus 1412 allows processor(s) 1402, memory device(s) 1404, interface(s) 1406, mass storage device(s) 1408, and I/O device(s) 1410 to communicate with one another, as well as other devices or components coupled to bus 1412. Bus 1412 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1400, and are executed by processor(s) 1402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate analysis of web-based content and generation of recommendations to enhance search engine results for the web-based content. Additionally, some embodiments are used in conjunction with one or more conventional content editing systems and methods. For example, one embodiment is used as an improvement of existing content editing systems.

Although the components and modules illustrated herein are shown and described in a particular arrangement, the arrangement of components and modules may be altered to perform analysis and generate recommendations in a different manner. In other embodiments, one or more additional components or modules may be added to the described systems, and one or more components or modules may be removed from the described systems. Alternate embodiments may combine two or more of the described components or modules into a single component or module.

Although specific embodiments of the invention have been described and illustrated, the invention is not to be limited to the specific forms or arrangements of parts so described and illustrated. The scope of the invention is to be defined by the claims appended hereto and their equivalents.

1. A computer-implemented method comprising:
receiving search optimization advice;
applying the search optimization advice to a web page associated with a web site;
generating a recommendation to modify the web page for improved search engine performance based on application of the search optimization advice; and
displaying the recommendation to modify the web page proximate web page content associated with the recommendation.

2. A method as recited in claim 1 further comprising displaying a user interface that allows a user to apply the recommendation to the web page.

3. A method as recited in claim 1 wherein displaying the recommendation includes displaying recommended changes to the web page content.

4. A method as recited in claim 1 further comprising displaying an option to apply the recommended changes to the web page content.

5. A method as recited in claim 1 further comprising:
identifying implementation of the recommendation; and
updating displayed information based on implementation of the recommendation.

6. A method as recited in claim 5 further comprising updating the web page content on the web site.

7. A method as recited in claim 1 further comprising retrieving a plurality of parameters associated with the search optimization advice.

8. A method as recited in claim 1 wherein the recommendation is associated with keywords used in the web page.

9. A method as recited in claim 1 wherein the recommendation is associated with tags contained in the web page.

10. A method as recited in claim 1 wherein the recommendation is associated with inbound links to the web page.

11. A method as recited in claim 1 wherein the search optimization advice is received from a search optimization tool.

12. A method as recited in claim 1 further comprising notifying a web page administrator if content is posted to the web site prior to complying with all generated recommendations.

13. A computer-implemented method of analyzing web-based content for improved search engine results, the method comprising:
receiving current search optimization advice associated with web-based content;
applying the search optimization advice to a plurality of web pages associated with a web site;
generating a plurality of recommendations to modify the web pages for improved search engine performance based on application of the search optimization advice;
displaying the plurality of recommendations to modify the web pages proximate the web page content associated with the recommendation; and
displaying an option to apply at least one of the plurality of recommendations to the web page content.

14. A method as recited in claim 13 wherein at least one of the plurality of recommendations is associated with keywords contained in the web page.

15. A method as recited in claim 13 wherein at least one of the plurality of recommendations is associated with tags contained in the web page.

16. A method as recited in claim 13 wherein at least one of the plurality of recommendations is associated with inbound links to the web page.

17. A method as recited in claim 13 further comprising storing the plurality of recommendations.

18. A method as recited in claim 13 further comprising updating the plurality of recommendations in response to application of at least one recommendation to the web page content.

19. A computer-implemented method comprising:
retrieving a plurality of web pages associated with a web site;
receiving search optimization advice;
applying the search optimization advice to each of the plurality of web pages;
identifying a set of web pages from the plurality of web pages that are not compliant with the search optimization advice;
displaying the set of web pages that are not compliant with the search optimization advice.

20. A method as recited in claim 19 further comprising displaying a user interface that allows a user to apply recommended changes to the displayed set of web pages that are not compliant with the search optimization advice.
